(19) United States
(12) Patent Application Publication
(10) Pub. No.: US 2025/0290846 A1
(43) Pub. Date: Sep. 18, 2025

(54) MULTI-PASS CELLS

(71) Applicant: BEIJING NORMAL UNIVERSITY, Beijing (CN)

(72) Inventors: Xin ZHOU, Beijing (CN); Yiyun GAI, Beijing (CN); Wenjin LI, Beijing (CN); Kaihao YI, Beijing (CN); Xue OU, Beijing (CN); Peng LIU, Beijing (CN)

(21) Appl. No.: 19/223,134

(22) Filed: May 30, 2025

Related U.S. Application Data
(63) Continuation of application No. PCT/CN2024/093049, filed on May 14, 2024.

(30) Foreign Application Priority Data
Apr. 25, 2024 (CN) 202410509270.9

(51) Int. Cl. G01N 21/03; G01N 21/3504

(52) U.S. Cl. CPC G01N 21/031; G01N 21/3504

(57) ABSTRACT

The present invention discloses multi-pass cells, which comprise aiming-side mirror and incident-side mirror arranged relatively on both sides, wherein both sides respectively comprise a plurality of spherical mirrors spliced to each other, wherein a total of n circulation components are formed based on incident-side mirror and aiming-side mirror, wherein any circulation component includes field mirror and objective mirror arranged relatively on both sides, wherein n is positive integer greater than or equal to 2, wherein light is suitable for being incident from point of incidence on one side of field mirror and aiming at the geometric center of objective mirror, wherein light is suitable for being emergent from point of emergence on one side of field mirror after n-fold cyclic reflection between incident-side mirror and aiming-side mirror, and wherein multiple rows as well as columns of light spots respectively on aiming-side mirror and incident-side mirror are finally formed. The present invention can achieve synchronous improvement in the utilization rate of the mirror and number of reuses of light spot's spatial position, thereby improving optical path.

### TECHNICAL FIELD

The present invention relates to the technical field of trace gas monitoring and especially to multi-pass cells.

### BACKGROUND

The high-precision trace gas detection is crucial in the technical fields of greenhouse gas monitoring, respiratory diagnosis, semiconductor processing as well as air pollution control. For instance, the long-term, continuous and high-precision measurement of background concentration of major greenhouse gases such as CH₄, CO₂ and N₂O is of great significance to the study of global climate change and corresponding greenhouse gas emissions. In biomedicine, accurate monitoring of metabolic markers in respiratory gases at sub-ppb levels can help to achieve the non-invasive diagnosis of human diseases and facilitate early treatment of potential diseases. Special advanced semiconductor processes require that concentration of harmful gas impurities be less than 100 ppt, and accurate online monitoring of harmful gas impurities can ensure the product qualification rate and safe operation of equipment. Through online high-precision analysis of key pollutants at trace level such as NO_{X}, SO₂, H₂S and NH₃ in atmospheric environment, characteristics, sources as well as change mechanisms of the atmospheric pollution can be deeply understood, thereby achieving precise regulation and effectively preventing accidents that endanger human health as well as the ecological environment. The cavity ring-down spectroscopy (CRDS) as well as off-axis integrated cavity output spectroscopy (OA-ICOS) can use an optical resonator with a kilometer-level optical path to meet strict measurement accuracy requirements of above trace gases. However, structure of such systems is relatively complex, and the measurement environment is demanding and costly, so it is difficult to achieve large-scale application in the complex and diverse practical scenarios. Tunable diode laser absorption spectroscopy (TDLAS) combined with the measurement scheme of multi-pass cells has the advantages of simple structure, low instrument costs, and high reliability. It is the most promising candidate to overcome above shortcomings. However, mirror utilization rate of currently designed multi-pass cells and number of reuses of light spot's spatial position are low, which results in length of optical path being limited to hundred-meter level, thereby limiting the detection accuracy of trace gases by the existing technical solution.

Therefore, multi-pass cells are required to solve technical problems existing in the above technical solution.

### SUMMARY

The present invention provides the multi-pass cells, aiming to solve or at least alleviate the above-mentioned technical problems.

According to one aspect of the present invention, the multi-pass cells are provided, which comprise an incident-side mirror and an aiming-side mirror arranged relatively on the both sides, wherein incident-side mirror and aiming-side mirror respectively comprise a plurality of spherical mirrors spliced to each other, wherein a total of n circulation components are formed based on the incident-side mirror and the aiming-side mirror, wherein any of circulation components comprises a field mirror as well as an objective mirror arranged relatively on both sides, wherein n is a positive integer greater than or equal to 2, wherein the light is suitable for being incident from the point of incidence on one side of field mirror of one of circulation components, aiming at the geometric center of an objective mirror of the present circulation component, wherein light is also suitable for being emergent from the point of emergence on one side of the field mirror of circulation components after n-fold cyclic reflection between incident-side mirror and aiming-side mirror, and wherein multiple rows and columns of light spots respectively on aiming-side mirror as well as incident-side mirror are finally formed.

Optionally, in the multi-pass cells according to the present invention, the geometric center of an objective mirror of present circulation component serves as the original aiming point, wherein a new circulation component can be formed based on the spherical mirror at original aiming point, the first new spherical mirror and the second new spherical mirror by additionally setting first new spherical mirror and second new spherical mirror at the positions of incident point and emergent point on the side of field mirror of one of the circulation components, wherein the spherical mirror at original aiming point serves as the field mirror of the new circulation component, while first new spherical mirror and second new spherical mirror serves respectively as objective mirror of the new circulation component, wherein light is suitable for being incident from the new point of incidence on one side of field mirror of new circulation component, aiming at the geometric center of first new spherical mirror or second new spherical mirror, wherein light is also suitable for being emergent from the new point of emergence on one side of the field mirror of new circulation component after (n+1)-fold cyclic reflection between aiming-side mirror and incident-side mirror, and wherein the multiple rows and columns of the light spots respectively on aiming-side mirror and incident-side mirror are finally formed.

Optionally, in the multi-pass cells according to the present invention, types of circulation components comprise Pickett Bradley White cell (PBWC) component, Bernstein Herzberg White cell (BHWC) component and Chernin multi-pass matrix system.

Optionally, in the multi-pass cells according to the present invention, incident-side mirror comprises the first spherical mirror and the second spherical mirror spliced to each other, wherein aiming-side mirror comprises a third spherical mirror, a fourth spherical mirror as well as a fifth spherical mirror spliced to each other, wherein the first circulation component is formed based on the third spherical mirror, the first spherical mirror as well as the second spherical mirror, wherein third spherical mirror serves as field mirror of first circulation component, wherein the first spherical mirror and the second spherical mirror respectively serve as the objective mirrors of first circulation component, wherein second circulation component is formed based on the second spherical mirror, the fourth spherical mirror and the fifth spherical mirror, wherein second spherical mirror serves as field mirror of the second circulation component, wherein fourth spherical mirror as well as fifth spherical mirror respectively serve as the objective mirror of second circulation component, wherein light is suitable for being incident from point of incidence on one side of second spherical mirror, aiming at the geometric center of the fifth spherical mirror, wherein light is also suitable for being emergent from point of emergence on one side of the second spherical mirror after two-fold cyclic reflection between aiming-side mirror and incident-side mirror, wherein each time light undergoes a complete reflection process on the first circulation component, it undergoes a further reflection on the second circulation component and forms a light spot on field mirror of the second circulation component, and wherein two columns of light spots are formed on the aiming-side mirror and four columns of light spots are formed on the incident-side mirror.

Optionally, in multi-pass cells according to the present invention, curvature radii of first spherical mirror, second spherical mirror, third spherical mirror, fourth spherical mirror as well as fifth spherical mirror are equal, wherein mirror spacing between incident-side mirror and aiming-side mirror is equal to the curvature radius.

Optionally, in multi-pass cells according to present invention, first circulation component and the second circulation component are respectively PBWC component or BHWC component.

Optionally, in the multi-pass cells according to the present invention, the first circulation component and the second circulation component are respectively PBWC component, wherein the first spherical mirror, the second spherical mirror, the third spherical mirror, the fourth spherical mirror as well as the fifth spherical mirror are all rectangular concave spherical mirrors, wherein projection shapes of incident-side mirror and aiming-side mirror are both rectangular, and wherein each reflection comprises multiple reflections respectively.

Optionally, in the multi-pass cells according to the present invention, first curvature center of the first spherical mirror is located at geometric center of the third spherical mirror, wherein the second curvature center of the second spherical mirror is located directly below the first curvature center, wherein the third curvature center of the third spherical mirror is located at center position on the dividing line between the first spherical mirror and the second spherical mirror, wherein the fourth curvature center of fourth spherical mirror is located at geometric center of second spherical mirror and is on same horizontal line as the third curvature center, and wherein the fifth curvature center of the fifth spherical mirror is located directly above the fourth curvature center.

Optionally, in the multi-pass cells according to present invention, it is suitable for forming a plurality of continuous light spots on the first circulation component whenever light undergoes a complete reflection process on the first circulation component.

Optionally, in the multi-pass cells according to present invention, a plurality of continuous light spots are formed on first circulation component, wherein a light spot sequence is sequentially formed on field mirror of the first circulation component, wherein the light spot sequence comprises a third number of light spots, wherein a second number of light spots are overlapped at the identical position on second spherical mirror of the first circulation component, wherein the second number is used to represent number of reuses of each light spot's spatial location on the second spherical mirror, wherein a first number of light spots are overlapped at identical position on first spherical mirror of first circulation component, and wherein the first number is used to represent the number of reuses of each light spot's spatial location on the first spherical mirror.

Optionally, in the multi-pass cells according to present invention, it is suitable for forming continuous 2×(2×n₂−1) light spots on the first circulation component whenever the light undergoes a complete reflection process on first circulation component, wherein n₂ represents number of light spot rows formed by the light on aiming-side mirror, wherein it is suitable for forming the first to 2×(2×n₂−1)^{th} light spots on the first circulation component whenever light undergoes first complete reflection process on the first circulation component, wherein the first number is n₂−1, and wherein the second number is n₂.

Optionally, in the multi-pass cells according to present invention, the number of complete reflection processes performed by light on first circulation component is equal to number of light spots formed on field mirror of second circulation component which is 2×n₁, wherein n₁ represents number of light spot rows formed on incident-side mirror by light, wherein the number of reuses of each light spot's spatial location on the field mirror of the first circulation component is equal to number of complete reflection processes performed by light on first circulation component which is 2×n₁.

Optionally, in the multi-pass cells according to present invention, total number of passes of multi-pass cells is N_{PP}=[2×(2×n₂−1)]×(2×n₁)+2, wherein n₁ as well as n₂ are both positive integers, wherein optical path of multi-pass cells is opl=N_{PP}×d, and wherein d represents mirror spacing between the incident-side mirror and the aiming-side mirror.

Optionally, in the multi-pass cells according to the present invention, the distance between the first curvature center of the first spherical mirror and the second curvature center of the second spherical mirror is dᵣ₂/2, wherein dᵣ₂ represents the spacing between the light spot rows on aiming-side mirror, wherein the distance between the fourth curvature center of the fourth spherical mirror as well as the fifth curvature center of the fifth spherical mirror is dᵣ₁/2, and wherein dᵣ₁ represents spacing between light spot rows on the incident-side mirror.

Optionally, in multi-pass cells according to present invention, first circulation component as well as second circulation component are respectively the BHWC component as well as PBWC component, wherein the third spherical mirror is the rectangular concave spherical mirror with two upper and lower notches, wherein the first spherical mirror, the second spherical mirror, the fourth spherical mirror as well as the fifth spherical mirror are all rectangular concave spherical mirrors and the fourth spherical mirror as well as the fifth spherical mirror are arranged at the two notches of third spherical mirror, wherein projection shapes of incident-side mirror as well as aiming-side mirror are both rectangular, and wherein light is suitable for emerged from the point of emergence above the second spherical mirror and horizontally adjacent to the point of incidence.

Optionally, in the multi-pass cells according to the present invention, the first circulation component and the second circulation component are respectively PBWC component and BHWC component, wherein the second spherical mirror is rectangular concave spherical mirror with the two upper and lower notches, wherein first spherical mirror, third spherical mirror, fourth spherical mirror and fifth spherical mirror are all rectangular concave spherical mirrors, wherein projection shape of aiming-side mirror is rectangular, wherein light is suitable for being incident from point of incidence at the notch above the second spherical mirror, aiming at geometric center of the fifth spherical mirror, and wherein light is also suitable for being emergent from the point of emergence at the notch below the second spherical mirror.

Optionally, in the multi-pass cells according to the present invention, the first circulation component and the second circulation component are respectively a BHWC component, wherein first spherical mirror and second spherical mirror are respectively rectangular concave spherical mirrors with one notch on top and are symmetrical with respect to y-axis, wherein third spherical mirror is rectangular concave spherical mirror with two upper and lower notches, wherein fourth spherical mirror and fifth spherical mirror are both rectangular concave spherical mirrors, wherein fourth spherical mirror as well as fifth spherical mirror are arranged at the two notches of the third spherical mirror, wherein projection shape of the aiming-side mirror is rectangular, wherein light is suitable for being incident from point of incidence at notch of second spherical mirror, aiming at geometric center of fifth spherical mirror, and wherein light is also suitable for being emergent from point of emergence at the notch of first spherical mirror.

According to the multi-pass cells provided by the present invention, it comprises incident-side mirror and aiming-side mirror arranged relatively on both sides, wherein incident-side mirror as well as aiming-side mirror respectively comprises a plurality of spherical mirrors spliced with each other, and wherein a plurality of circulation components in total are formed based on incident-side mirror and aiming-side mirror. Any circulation component comprises field mirror and objective mirror arranged relatively on the both sides, and light can be incident from point of incidence on one side of field mirror of one of the circulation components and aim at the geometric center of objective mirror of the present circulation component. After the multi-fold cyclic reflections between incident-side mirror and aiming-side mirror, it is emergent from point of emergence on one side of the field mirror of present circulation component. Finally, multiple rows and columns of light spots are formed on aiming-side mirror and incident-side mirror. The multi-pass cells of the present invention has simple structure and can achieve synchronous improvement in the utilization rate of bilateral mirrors as well as number of reuses of light spot's spatial position, thereby enhancing optical path and further improving detection accuracy and stability of the multi-pass cells for trace gases.

Furthermore, according to technical solution of the present invention, by adding two new spherical mirrors at the point of incidence and the point of emergence on one side of the field mirror of one of circulation components, the new circulation component can be formed based on spherical mirror at original aiming point, the first new spherical mirror and the second new spherical mirror. Besides, the spherical mirror at the original aiming point is used as the field mirror of new circulation component, and the two new spherical mirrors are used as the objective mirrors of new circulation component, thereby obtaining the multi-pass cells with more multi-fold reflection. In this way, by increasing the number of circulation components, the optical path and optical path-to-volume ratio of the multi-pass cells can be further improved.

The above description is only an overview of technical solutions of the present invention. For a thorough understanding of the technical means of the present invention, and implementation in accordance with specification, and that above described and other objectives, features as well as advantages of the present invention can be more clearly understood, the detailed description of preferred embodiments can be described in detail with reference to the accompanying drawings.

### BRIEF DESCRIPTION OF DRAWINGS

To achieve the above and related objectives, certain illustrative aspects of claimed subject matter are described herein in conjunction with following description and accompanying drawings. These aspects are indicative of various aspects of implementing the subject matter, and all of which are intended to fall within the scope of claimed subject matter. The foregoing and other objectives, aspects, features as well as advantages of present invention will become more apparent and better understood by referring to the following description taken in conjunction with the accompanying drawings. In the present invention, the same reference numerals generally refer to the same or like components or elements throughout the drawings.

FIG. 1A and FIG. 1B are respectively a schematic diagram showing structure of existing classic PBWC component and a schematic diagram showing pattern of light spot formed on field mirror.

FIG. 2A and FIG. 2B are respectively a schematic diagram showing structure of the multi-pass cells 200 provided according to embodiment of the present invention and a schematic diagram showing pattern of light spot formed on mirror on both sides of the present multi-pass cells 200.

FIG. 3 is a schematic diagram showing the formation sequence of the first 28 light spots formed on mirror on both sides of multi-pass cells according to embodiment of present invention.

FIG. 4 is a schematic diagram showing formation sequence of 114 complete light spots formed on the mirror on the both sides of the multi-pass cells after 114 times of passes according to embodiment of the present invention, wherein point of emergence “out” can be regarded as the 114^{th} light spot.

FIG. 5 is a schematic diagram showing positional relationship between light spots formed on mirror on both sides of multi-pass cells based on PBWC-PBWC and curvature center of each spherical mirror according to embodiment of the present invention.

FIG. 6A and FIG. 6B are respectively a schematic diagram showing structure of existing classic BHWC component and a schematic diagram showing pattern of light spot formed on field mirror.

FIG. 7 is a schematic diagram showing positional relationship between light spots formed on mirror on both sides of multi-pass cells based on BHWC-PBWC and curvature center of each spherical mirror according to embodiment of the present invention.

FIG. 8 is a schematic diagram showing positional relationship between light spots formed on mirror on both sides of multi-pass cells based on PBWC-BHWC and curvature center of each spherical mirror according to embodiment of the present invention.

FIG. 9 is a schematic diagram showing positional relationship between light spots formed on the mirror on both sides of the multi-pass cells based on BHWC-BHWC and curvature center of each spherical mirror according to embodiment of the present invention.

FIG. 10 is a schematic diagram showing the pattern of the light spot formed on the mirror on both sides of the multi-pass cells based on PBWC-PBWC-PBWC according to embodiment of the present invention.

FIG. 11 is a line graph showing optical path and optical path-to-volume ratio of the n-fold circulation multi-pass cells with different numbers of light spot rows on field mirror of PBWC.

### DETAILED DESCRIPTION OF THE EMBODIMENTS

The exemplary embodiments of present invention will be described in more detail below with reference to accompanying drawings. Although exemplary embodiments of present invention are shown in accompanying drawings, the present invention can be implemented in various forms and should not be limited by the embodiments set forth herein. On the contrary, these embodiments are provided to enable a more thorough understanding of the present technical solution and to fully convey the scope of the present invention to those skilled in the art.

It should be illustrated that PBWC components and BHWC components are basic devices of multi-pass cells.

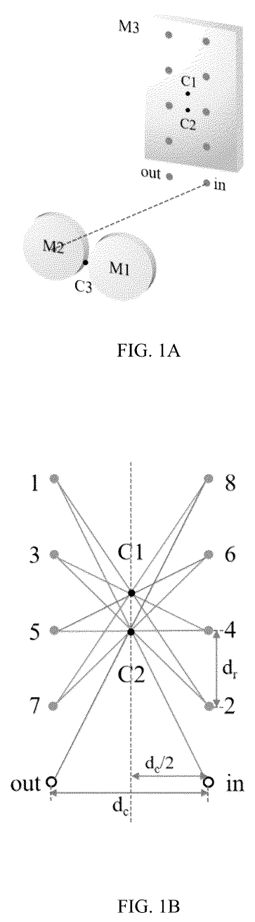

FIG. 1A and FIG. 1B are respectively a schematic diagram showing structure of existing classic PBWC component and a schematic diagram showing pattern of light spot formed on field mirror. As shown in FIG. 1A and FIG. 1B, the classic PBWC component is composed of three concave spherical mirrors with equal curvature radii. For ease of description, the side where light is incident is called incident side, while the side where light is aimed is called aiming side. The number of the reflections of the same light spot's spatial position, that is, the number of overlapping light spots, is called the number of reuses of light spot's spatial position. The spherical mirror on incident side of the classic PBWC component is rectangular field mirror M3, and the aiming side has two circular objective mirrors M1 and M2. The mirror spacing between two sides of mirror is equal to curvature radius of spherical mirror. The curvature center C1 of objective mirror M1 and the curvature center C2 of objective mirror M2 are located on the field mirror M3 and do not overlap. The curvature center C3 of field mirror M3 is located at center of objective mirror M1 and objective mirror M2. The reflection law of classic PBWC component is as follows: as confocal resonant cavity, the cells refocus image of the incident aperture onto field mirror until the light beam leaves the cells and finally forms two columns of the light spots on the field mirror M3. The total number of light spots is 2×n_{PBWC}, wherein n_{PBWC} is the number of light spot rows formed on field mirror M3, and wherein the number of reuses of each light spot's spatial position is 1. The first and second columns of light spots on field mirror M3 are respectively focused by objective mirror M2 as well as objective mirror M1. The number of the light spots on objective mirror M1 as well as objective mirror M2 is 1, while number of reuses of light spot's spatial position on objective mirror M1 is n_{PBWC}, and number of reuses of light spot's spatial position on objective mirror M2 is n_{PBWC}+1. The number of passes of the classic PBWC component N_{PBWC} is calculated as follows:

N_{PBWC}=2×(2×n_{PBWC}+1)

According to the reflection law of the classic PBWC component, light spots on field mirror M3 of the classic PBWC component are evenly distributed, and the mirror utilization rate is high. However, each light spot is only reflected once, wherein the number of reuses of each light spot's spatial position on the field mirror M3 is 1. The number of reuses of light spot's spatial position on objective mirror M1 and the objective mirror M2 is high, but there is only one light spot, and the mirror utilization rate is low.

In view of defects as well as shortcomings of the classic PBWC component, and in order to simultaneously increase number of reuses of light spot's spatial position on field mirror M3 and the mirror utilization rate on the objective mirrors M1 and M2, the multi-pass cells 200 are provided in embodiment of the present invention.

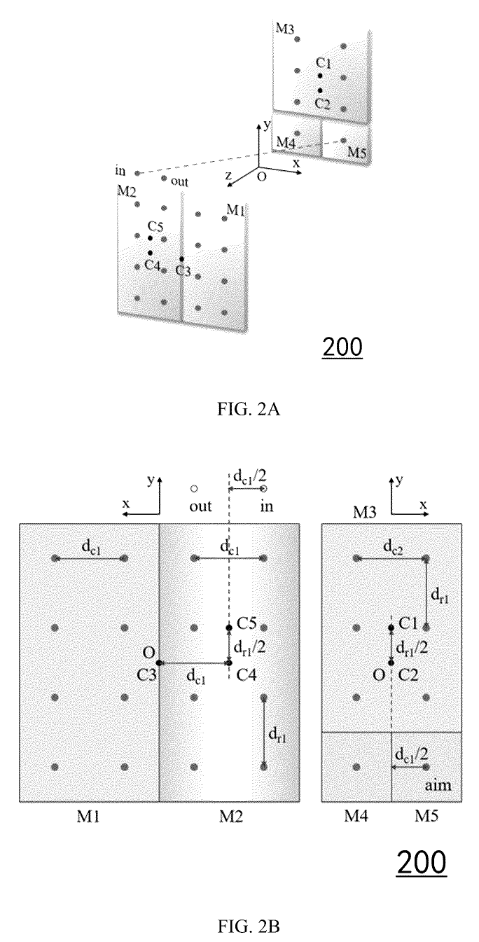

FIG. 2A and FIG. 2B are respectively a schematic diagram showing structure of the multi-pass cells 200 provided according to embodiment of the present invention and a schematic diagram showing pattern of light spot formed on mirror on both sides of the present multi-pass cells 200. It should be illustrated that pattern of light spot formed on the mirror on either side can be observed by standing in the center of the multi-pass cells 200 and facing the mirror on either side.

As shown in FIG. 2A and FIG. 2B, the Cartesian coordinate system is established by taking the midpoint of the line connecting the geometric centers of the mirrors on both sides of the multi-pass cells 200 as origin point O and straight line where the line connecting geometric centers lies as the z-axis.

In several embodiments, the present invention makes three major improvements to classic PBWC component: 1) adding two rectangular spherical mirrors M4 as well as M5 at original point of incidence and at original point of emergence of PBWC, 2) changing objective mirrors M1 as well as M2 from circular shape to rectangular shape, so that M2 and the newly added M4 as well as M5 form the new PBWC and 3) adjusting position of point of incidence as well as point of emergence from the side of field mirror M3 to the side of objective mirror M2.

Based on above improvements, five rectangular spherical mirrors can be used to form two independent PBWC components, and the multi-pass cells 200 of present invention can be obtained. In the present multi-pass cells 200, M2 is the objective mirror of classic PBWC component, and each light spot on M2 has a relatively high number of the spatial position reuses. At the same time, M2 is field mirror of the newly added PBWC component as well, and two columns of light spots will be formed on M2, and two columns of the mirror light spots will be formed on M1, thereby improving the mirror utilization rate of M1 and M2 greatly. Utilizing the principle of optical path reversibility, by setting the newly added objective mirrors M4 and M5 at the emergent and incident positions of classic PBWC component, mutual nesting of reflection processes of the two PBWC components can be achieved, so that the field mirror M3 can maintain a high mirror utilization rate, while number of reuses of each light spot's spatial position is also effectively increased. The multi-pass cells 200 designed in the two-fold circulation mode based on bilateral field mirror according to the present invention can achieve simultaneous increase in the utilization rate of bilateral mirrors and in number of reuses of the light spot's spatial position, while maintaining a simple structure of cells, thereby increasing the optical path.

It is worth noting that in some embodiments, multi-pass cells 200 of the present invention can be obtained based on two PBWC components, that is, in the multi-pass cells 200 of the present invention, two PBWC components can be formed based on five spherical mirrors, but the present invention is not limited thereto.

In other embodiments, in multi-pass cells 200 of the present invention, PBWC component and BHWC component may be formed based on five spherical mirrors, or two BHWC components may be formed based on five spherical mirrors.

In the embodiment of the present invention, as shown in FIG. 2A and FIG. 2B, multi-pass cells 200 comprises the incident-side mirror and the aiming-side mirror arranged relatively on two sides which are incident side and aiming side. The incident-side mirror and the aiming-side mirror comprise 5 spherical mirrors in total, specifically rectangular concave spherical mirrors, wherein incident-side mirror arranged on the incident side comprises the first spherical mirror M1 and the second spherical mirror M2 spliced to each other, while the aiming-side mirror arranged on aiming side comprises the third spherical mirror M3, the fourth spherical mirror M4 and the fifth spherical mirror M5 spliced to each other.

In multi-pass cells 200 of the present invention, two circulation components (namely first circulation component and second circulation component) can be formed based on five spherical mirrors. The both circulation components can be two PBWC components (PBWC-PBWC), or the both circulation components can be the PBWC component as well as BHWC component (BHWC-PBWC or PBWC-BHWC), or both circulation components can be two BHWC components. That is, the first circulation component and the second circulation component can be PBWC component or BHWC component respectively, and present invention does not impose any specific restrictions on this.

It should be illustrated that FIG. 2A and FIG. 2B show the multi-pass cells 200 based on PBWC-PBWC, that is, two PBWC components are formed based on five spherical mirrors. The following describes the multi-pass cells 200 in the embodiment of the present invention in detail by taking the multi-pass cells 200 based on PBWC-PBWC as an example.

As shown in FIG. 2A and FIG. 2B, the first circulation component can be formed based on the third spherical mirror M3, the first spherical mirror M1 and the second spherical mirror M2, wherein the third spherical mirror M3 serves as field mirror of the first circulation component, and wherein first spherical mirror M1 as well as second spherical mirror M2 respectively serve as the objective mirror of first circulation component. Furthermore, second circulation component can be formed based on second spherical mirror M2, fourth spherical mirror M4 and fifth spherical mirror M5, wherein second spherical mirror M2 serves as field mirror of the second circulation component, and wherein fourth spherical mirror M4 as well as fifth spherical mirror M5 serve as objective mirror of the second circulation component.

It should be noted that first circulation component and second circulation component can respectively be the PBWC component or the BHWC component, and the present invention does not specifically limit this. In several embodiments, first circulation component as well as second circulation component can respectively be a PBWC component, for example, the first circulation component and the second circulation component are PBWC-a and PBWC-b respectively.

In the embodiment of the present invention, as shown in FIG. 2A and FIG. 2B, light can be incident from point of incidence “in” on one side (for example, above) of the second spherical mirror M2 (field mirror of the second circulation component) on the incident side into the multi-pass cells 200, and aim at the geometric center of fifth spherical mirror M5 of the second circulation component which is one of the objective mirrors of the second circulation component, that is, the aiming point “aim” is located at geometric center of the fifth spherical mirror M5 on the aiming side which is one of the objective mirrors of the second circulation component. The incident light undergoes two-fold reflection between mirrors on both sides (incident-side mirror and aiming-side mirror) and then emerges, wherein each circulation comprises multiple reflections. In the two-fold cyclic reflection process, every time the light undergoes a complete reflection process on the first circulation component, it will undergo a step of reflection on second circulation component and form a light spot on field mirror M2 of second circulation component. Finally, two columns of light spots can be formed on aiming-side mirror (third spherical mirror M3, fourth spherical mirror M4 and fifth spherical mirror M5), that is, multiple rows and two columns of the light spots, and four columns of light spots can be formed on incident-side mirror (first spherical mirror M1 and second spherical mirror M2), that is, multiple rows and four columns of light spots.

In some embodiments, the first spherical mirror M1, the second spherical mirror M2, the third spherical mirror M3, the fourth spherical mirror M4 as well as the fifth spherical mirror M5 have same curvature radius which can be represented as R, and the mirror spacing d between the incident-side mirror and the aiming-side mirror is equal to curvature radius R. In one embodiment, the curvature radius of each spherical mirror is 1 m, but the present invention is not limited thereto.

In some embodiments, as shown in FIG. 2A as well as 2B, first spherical mirror M1, second spherical mirror M2, third spherical mirror M3, fourth spherical mirror M4 and the fifth spherical mirror M5 can all be rectangular concave spherical mirror. Second circulation component formed based on second spherical mirror M2, fourth spherical mirror M4 and fifth spherical mirror M5 is specifically the second PBWC component (PBWC-b), and the first circulation component formed based on third spherical mirror M3, first spherical mirror M1 as well as second spherical mirror M2 is specifically first PBWC component (PBWC-a), that is, the above-mentioned first circulation component as well as the second circulation component can respectively be a PBWC component. In addition, the projection shape of incident-side mirror composed of first spherical mirror M1 and second spherical mirror M2 is rectangle, and first spherical mirror M1 as well as second spherical mirror M2 are symmetrical with respect to y-axis. The projection shape of the aiming-side mirror composed of the third spherical mirror M3, the fourth spherical mirror M4 and the fifth spherical mirror M5 is rectangle.

Specifically, first spherical mirror M1 and second spherical mirror M2 have the same size and are arranged side by side on incident side. Specifically, first spherical mirror M1 and second spherical mirror M2 are spliced with each other along the x-axis direction, and the projection shape of incident-side mirror formed by first spherical mirror M1 and second spherical mirror M2 along the z-axis direction is rectangle. The fourth spherical mirror M4 and the fifth spherical mirror M5 have same size and are arranged side by side below the third spherical mirror M3 on aiming side, spliced with bottom end of third spherical mirror M3, and sum of widths of fourth spherical mirror M4 and fifth spherical mirror M5 is equal to width of third spherical mirror M3, so that projection shape of aiming-side mirror formed by the splicing of third spherical mirror M3, fourth spherical mirror M4 and fifth spherical mirror M5 along the z-axis direction is rectangle.

It should be noted that Cn is used to represent the curvature center of the spherical mirror Mn. The curvature centers of first spherical mirror M1, second spherical mirror M2, third spherical mirror M3, fourth spherical mirror M4 as well as fifth spherical mirror M5 are respectively first curvature center C1, second curvature center C2, third curvature center C3, fourth curvature center C4 and fifth curvature center C5.

As shown in FIG. 2A and FIG. 2B, the spatial positions of the curvature centers of the five spherical mirrors are arranged as follows: the first curvature center C1 of first spherical mirror M1 on the incident side is located at geometric center of third spherical mirror M3 on the aiming side, and second curvature center C2 of second spherical mirror M2 on incident side is located directly below the first curvature center C1. The third curvature center C3 of the third spherical mirror M3 is located at the center position on the boundary line between first spherical mirror M1 and second spherical mirror M2. The fourth curvature center C4 of the fourth spherical mirror M4 is located at geometric center of second spherical mirror M2 on incident side and is on the same horizontal line as the third curvature center C3. The fifth curvature center C5 of the fifth spherical mirror M5 is located directly above the fourth curvature center C4.

The light can be incident from point of incidence “in” on upper side of second spherical mirror M2 which is located at incident side as field mirror of second circulation component into the multi-pass cells 200 and aim at geometric center of the fifth spherical mirror M5 which is one of objective mirrors of second circulation component, that is, the aiming point “aim” is located at the geometric center of fifth spherical mirror M5 on aiming side which is one of the objective mirrors of the second circulation component. After the incident light undergoes two-fold cyclic reflection between both sides of the mirror (incident-side mirror as well as aiming-side mirror), it can finally be emergent from point of emergence “out” on upper side of second spherical mirror M2, wherein point of emergence “out” can be horizontally adjacent to the point of incidence “in”. The process of two-fold cyclic reflection includes: every time light undergoes a complete reflection process on first circulation component, it will undergo a step of reflection on second circulation component and form a light spot on field mirror M2 of the second circulation component, and finally be emergent after undergoing multiple processes of complete reflection on first circulation component. Finally, two columns of light spots are formed on aiming-side mirror (third spherical mirror M3, fourth spherical mirror M4 and fifth spherical mirror M5), that is, multiple rows and two columns of light spots, and four columns of light spots on incident-side mirror (first spherical mirror M1 and second spherical mirror M2) are formed, that is, multiple rows and four columns of light spots.

For ease of description, the following takes multi-pass cells 200 in which number of rows of light spots formed on incident-side mirror and aiming-side mirror is 4 and number of passes is 114 as an example to illustrate the reflection law of light in the multi-pass cells 200.

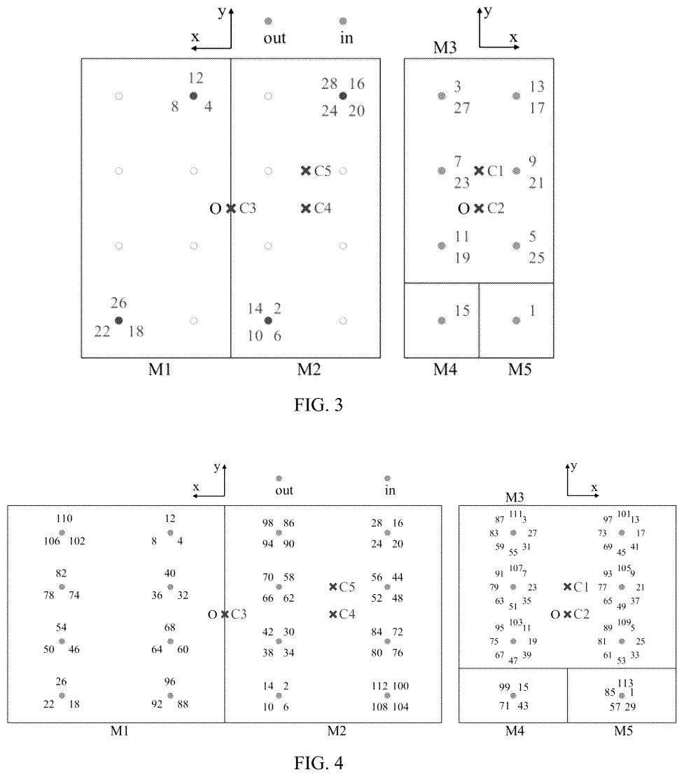

FIG. 3 is a schematic diagram showing the formation sequence of the first 28 light spots formed on mirror on both sides of multi-pass cells according to embodiment of present invention.

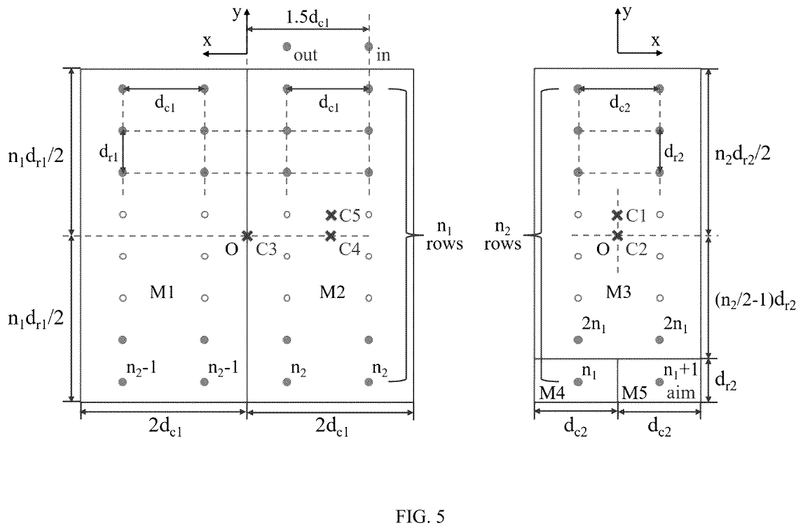

FIG. 4 is a schematic diagram showing formation sequence of 114 complete light spots formed on the mirror on the both sides of the multi-pass cells after 114 times of passes according to embodiment of the present invention, wherein point of emergence “out” can be regarded as the 114^{th} light spot.

It should be noted that the numbers in FIG. 3 and FIG. 4 are used to indicate the order in which the light spots are formed.

In some embodiments, as shown in FIG. 3, the reflection mode of light in the multi-pass cells 200 is as follows: the light enters the multi-pass cells 200 from the point of incidence “in” of second circulation component and takes geometric center “1” of fifth spherical mirror M5 of the second circulation component (PBWC-b) which is objective mirror as aiming point and undergoes the first reflection. Then, the light forms the light spot “2” at a new position on the field mirror M2 of the second circulation component which is the second spherical mirror, and the light spot “2” is symmetrical with the point of incidence “in” which is regarded as the curvature center C5 of the fifth spherical mirror M5. It can be understood as the first and second step of reflections performed on second circulation component. Since fifth spherical mirror M5 of second circulation component is exactly set at incident position of first circulation component, the process of light from position of light spot “1” on the fifth spherical mirror M5 to the position of light spot “2” on the second spherical mirror M2 is equivalent to the light incident on the first circulation component (PBWC-a). Next, the process of first complete reflection will be performed on first circulation component. Starting from the starting light spot “1” of the first circulation component, the light spot sequence “1-3-5-7-9-11-13” is formed in sequence on the side of field mirror of the first circulation component which is side of third spherical mirror, and light spot sequence comprises 7 light spots. In addition, 4 light spots “Feb. 6, 2010-14” are overlapped at the identical position on second spherical mirror M2 of the first circulation component which is objective mirror, that is, spatial position of light spots on second spherical mirror M2 is reused 4 times, while three corresponding light spots “Apr. 8, 2012” are overlapped at the same position on the first spherical mirror M1 of the first circulation component which is objective mirror, that is, the spatial position of light spots on the first spherical mirror M1 is reused 3 times. The 1^{st} to 14^{th} light spots can represent process of first complete reflection formed on the first circulation component.

Since the fourth spherical mirror M4 of second circulation component which is objective mirror is set exactly at emergent position of the first circulation component, when the light continues to be emergent from position of light spot “14” on the second spherical mirror M2 to position of light spot “15” on the fourth spherical mirror M4, a new light spot “16” will be formed on the field mirror M2 of second circulation component which is the second spherical mirror, and the light spots “16” as well as “14” are symmetrical about the curvature center C4 of the fourth spherical mirror M4. This can be understood as third step of reflection performed on second circulation component. At same time, according to principle of reversibility of optical path, the process of light emerged from the position of light spot “15” on M4 to the position of light spot “16” on M2 is equivalent to light, which is incident again on the first circulation component, where it will begin the process of second complete reflection. Starting from the starting light spot “15” of first circulation component, the light spot sequence “15-17-19-21-23-25-27” is formed in sequence on the side of the field mirror of first circulation component which is the side of third spherical mirror, and light spot sequence comprises 7 light spots. 4 light spots “16-20-24-28” are overlapped at the same position on second spherical mirror M2 of first circulation component which is objective mirror, while the corresponding 3 light spots “18-22-26” are overlapped at identical position on the first spherical mirror M1 of the first circulation component which is objective mirror. The 15^{th} to 28^{th} light spots can represent the process of second complete reflection formed on the first circulation component.

It can be found that during multiple reflections of the incident light between the incident-side mirror as well as the aiming-side mirror, that is, before light is emergent, each time the light undergoes a complete reflection process (i.e., a small cycle which is represented as a cell) on first circulation component, it will undergo a step of reflection on second circulation component (i.e., a step of reflection of large cycle which is represented as b cell), and form a new light spot on field mirror M2 (second spherical mirror) of second circulation component, in which one step of reflection corresponds to one light spot. In other words, each light spot on the field mirror of second circulation component corresponds to a complete process of light reflection on the first circulation component. Moreover, the one-step reflection on second circulation component, which is regarded as one-step reflection of large cycle b cell, is also the first step of reflection of next complete reflection process on first circulation component, which is next small cycle a cell. Finally, the light is emergent after undergoing multiple processes of complete reflection on first circulation component. Here, second circulation component corresponds to the large cycle b cell, while the first circulation component corresponds to small cycle a cell.

It should be noted that each time the light undergoes a process of complete reflection on first circulation component, a plurality of continuous light spots will be formed on first circulation component. For example, light undergoes first process of complete reflection on first circulation component and can form the 1^{st} to 14^{th} light spot on the first circulation component which is the 14 continuous light spots.

Furthermore, each time the light undergoes a process of complete reflection on the first circulation component, a plurality of the continuous light spots are formed on the first circulation component, specifically including: forming a light spot sequence sequentially on the side of field mirror of first circulation component which comprises a third number of light spots, overlapping to form a second number of light spots at the same position on the second spherical mirror M2 of the first circulation component, and overlapping to form a first number of light spots at same position on the first spherical mirror M1 of the first circulation component. Here, it can be understood that the second number is used to indicate the number of reuses of each light spot's spatial location on second spherical mirror M2, and the first number is used to indicate the number of reuses of each light spot's spatial location on first spherical mirror M1. It should be noted that the order in which the light spots are formed on the first circulation component can be seen in the numbers in FIGS. 3 and 4.

The above process is repeated until the eighth process of complete reflection of the first circulation component is completed. As shown in FIG. 4, the 114^{th} light spots which finally formed are symmetrical with the 112^{nd} light spots on second spherical mirror M2 about curvature center C5 of fifth spherical mirror M5, wherein point of emergence “out” can be regarded as 114^{th} light spot, that is, point of emergence “out” on the side of field mirror of the second circulation component is reached.

In some embodiments, it is assumed that the number of rows of light spots formed by the light on aiming-side mirror which comprises third spherical mirror M3, fourth spherical mirror M4 as well as fifth spherical mirror M5 is n₂. Then, each time the light undergoes a process of complete reflection on first circulation component, a continuous 2×(2×n₂−1) number of the light spots can be formed on first circulation component, wherein n₂ represents the number of rows of light spots formed by light on aiming-side mirror. In other words, above-mentioned continuous multiple light spots can specifically be a continuous 2×(2×n₂−1) number of light spots, wherein n₂ represents the number of rows of light spots formed by light on aiming-side mirror, and n₂ is a positive integer.

Accordingly, light undergoes the first process of complete reflection on first circulation component, forming the 1^{st} to 2×(2×n₂−1)^{th} light spots on the first circulation component. The light undergoes the second process of complete reflection on first circulation component, forming the 2×(2×n₂−1)+1^{th} to 4×(2×n₂−1)^{th} light spots on the first circulation component.

In several embodiments, assuming that the incident light undergoes multiple reflections between incident-side mirror and aiming-side mirror and emerges from the point of emergence of the second spherical mirror M2, the number of rows of light spots finally formed on the incident-side mirror (comprising first spherical mirror M1 and second spherical mirror M2) is n₁, then, after light undergoes the 2×n₁^{th} process of complete reflection on first circulation component, position of the 2×(2×n₂−1)×2×n₁+2^{th} light spot formed is position of point of emergence “out” above second spherical mirror M2.

Since the second spherical mirror M2 is field mirror of second circulation component, each light spot on the field mirror of second circulation component corresponds to a complete reflection process of light on first circulation component. Therefore, number of complete reflection processes of the light on the first circulation component is equal to the number of light spots formed on field mirror M2 (second spherical mirror) of second circulation component, which is 2×n₁. Among them, n₁ represents the number of light spot rows formed by the light on the incident-side mirror, and n₁ is a positive integer. In addition, number of reuses of each light spot's spatial position on field mirror M3 (third spherical mirror) of the first circulation component is equal to the number of complete reflection processes of light on the first circulation component, which is 2×n₁. It can be understood that every time the light undergoes a complete reflection process on the first circulation component, number of reuses of each light spot's spatial position on field mirror of the first circulation component is increased by 1.

Based on the theory of classical circulation components, it should be noted that in the first circulation component, number of reuses (i.e., the first number) of each light spot's spatial position on the first spherical mirror M1 (objective mirror) is n₂−1, and the number of reuses (i.e., the second number) of each light spot's spatial position on the first spherical mirror M1 (objective mirror) is n₂. In other words, first number is n₂−1, while second number is n₂, wherein n₂ represents number of light spot rows formed by light on the aiming-side mirror.

Based on theory of classical circulation components, in the second circulation component, the number of reuses of each light spot's spatial position on fourth spherical mirror M4 (objective mirror) is n₁, while the number of reuses of each light spot's spatial position on fifth spherical mirror M5 (objective mirror) is n₁+1. Among them, n₁ represents number of light spot rows formed by light on the incident-side mirror.

Based on this, total number of passes of the multi-pass cells 200 of the present invention is equal to the product of number of passes of first circulation component and number of complete reflection processes performed by light on first circulation component (that is, the number of light spots formed on field mirror of second circulation component which is 2×n₁) plus 2. That is, the total number of passes of multi-pass cells 200 is calculated as N_{PP}=[2×(2×n₂−1)]×(2×n₁)+2. N_{PP} represents total number of the passes of the multi-pass cells 200, while n₁ and n₂ are both positive integers. Here, the number of passes of first circulation component refers to the number of passes of the light on first circulation component for a complete reflection process, that is, the number of light spots formed on first circulation component for each complete reflection process performed by light on the first circulation component is 2×(2×n₂−1).

After determining total number of passes N_{PP} of the multi-pass cells 200, the optical path opl of the multi-pass cells 200 can be calculated based on the total number of passes N_{PP} and mirror spacing between incident-side mirror as well as aiming-side mirror. Specifically, optical path opl of the multi-pass cells 200 can be calculated as opl=N_{PP}×d=[2×(2×n₂−1)]×(2×n₁)×d+2×d, wherein d represents mirror spacing between the incident-side mirror and the aiming-side mirror.

It can be noted that optical path opl of multi-pass cells is related to following parameters: the number of light spot rows n₁ formed by light on incident-side mirror, the number of light spot rows n₂ formed by the light on aiming-side mirror and the mirror spacing d between the incident-side mirror and the aiming-side mirror which is equal to curvature radius of each spherical mirror. In this way, when mirror spacing d between incident-side mirror as well as aiming-side mirror is determined, multi-pass cells with different optical paths can be obtained by adjusting number of light spot rows n₁ formed by light on the incident-side mirror and the number of light spot rows n₂ formed by light on the aiming-side mirror.

FIG. 5 is a schematic diagram showing positional relationship between light spots formed on mirror on both sides of multi-pass cells based on PBWC-PBWC and curvature center of each spherical mirror according to embodiment of the present invention.

As shown in FIG. 5, on the aiming side, distance between curvature centers C1 and C2 of the both objective mirrors M1 and M2 of the first circulation component is half of spacing of light spot rows dᵣ₂ on field mirror M3 thereof. That is, distance between first curvature center C1 of first spherical mirror M1 and second curvature center C2 of second spherical mirror M2 is half of the spacing of light spot rows dᵣ₂ on the aiming-side mirror. In other words, the distance between first curvature center C1 of the first spherical mirror M1 and second curvature center C2 of the second spherical mirror M2 is dᵣ₂/2, wherein dᵣ₂ represents the spacing of light spot rows on aiming-side mirror. Based on this, by adjusting positions of the first curvature center C1 as well as the second curvature center C2, spacing of light spot rows on the aiming-side mirror can be adjusted, thereby increasing or decreasing number of light spot rows formed on aiming-side mirror. In addition, the distance between aiming point “aim” and C1 as well as C2 in the x-direction is half of the spacing of light spot columns d_{c2} on the aiming-side mirror.

On the incident side, distance between curvature centers C4 and C5 of the two objective mirrors M4 and M5 of the second circulation component is half of the spacing of light spot rows dᵣ₁ on incident-side mirror. That is, distance between fourth curvature center C4 of the fourth spherical mirror M4 and fifth curvature center C5 of the fifth spherical mirror M5 is half of spacing of light spot rows dᵣ₁ on the incident-side mirror. In other words, the distance between the fourth curvature center C4 of the fourth spherical mirror M4 and the fifth curvature center C5 of the fifth spherical mirror M5 is dᵣ₁/2, wherein dᵣ₁ represents the spacing of light spot rows on the incident-side mirror. Based on this, by adjusting positions of the fourth curvature center C4 and the fifth curvature center C5, the spacing of light spot rows on incident-side mirror can be adjusted, and the number of light spot rows formed on incident-side mirror can be increased or decreased. In addition, the distance between point of incidence “in” and C4 as well as C5 in x-direction is half of spacing of light spot columns de on incident-side mirror (M1 and M2). Furthermore, distance between third curvature centers C3, C4 and C5 in the x-direction is equal to spacing of light spot columns d_{c1} on incident-side mirror.

It can be understood that based on the above-mentioned reflection law as well as optical path calculation formula which is opl=N_{PP}×d=[2×(2×n₂−1)]×(2×n₁)×d+2×d, multi-pass cells with different optical paths can be designed according to the actual requirements. Specifically, by adjusting the positions of the fourth curvature center C4 as well as the fifth curvature center C5, spacing of the light spot rows on incident-side mirror can be adjusted, and then the number of light spot rows n₁ formed on incident-side mirror can be increased or decreased. By adjusting positions of the first curvature center C1 and the second curvature center C2, spacing of light spot rows on aiming-side mirror can be adjusted, and then number of light spot rows n₂ formed on aiming-side mirror can be increased or decreased. Based on this, the multi-pass cells with different numbers of light spot rows and different spacing of light spot rows can be obtained. The number of light spot rows n₁ formed by light on incident-side mirror and number of light spot rows n₂ formed by light on the aiming-side mirror can affect the optical path of the multi-pass cells, so that multi-pass cells with different optical paths can be obtained. For example, when the mirror spacing d is equal to 1 m, n₁ is equal to 20 and n₂ is equal to 20, the multi-pass cells with an optical path of three kilometers can be obtained.

As mentioned above, multi-pass cells include first spherical mirror M1, second spherical mirror M2, third spherical mirror M3, fourth spherical mirror M4 and fifth spherical mirror M5. The curvature radii (which can be represented as R) of first spherical mirror M1, second spherical mirror M2, third spherical mirror M3, fourth spherical mirror M4 as well as fifth spherical mirror M5 are equal, and the mirror spacing between the incident-side mirror and the aiming-side mirror is equal to the curvature radius R.

Referring to mirror coordinate axis shown in FIG. 5 and various parameters of the multi-pass cells based on PBWC-PBWC shown in Table 1 below, nₛₚₒₜₛ represents number of light spots on each spherical mirror, nᵣₑ represents number of reuses of the light spot's spatial position on each spherical mirror, and d represents the mirror spacing between incident-side mirror and aiming-side mirror. As shown in FIG. 5, in multi-pass cells, first curvature center C1 of first spherical mirror M1 and second curvature center C2 of second spherical mirror M2 are located on the aiming-side mirror. Third curvature center C3 of the third spherical mirror M3, fourth curvature center C4 of the fourth spherical mirror M4 as well as fifth curvature center C5 of the fifth spherical mirror M5 are located on the incident-side mirror. The point of incidence “in” is located on upper side of the second spherical mirror M2 (i.e., field mirror of second circulation component), and the aiming point “aim” is located at the geometric center of the fifth spherical mirror M5 (i.e., one of the objective mirrors of the second circulation component).

TABLE 1
Parameters of multi-pass cells based on PBWC-PBWC

| | M1 | M2 | M3 | M4 | M5 |
|---|---|---|---|---|---|
| Curvature | C1 (0, | C2 (0, | C3 (0, 0, | C4 (−d_{c1}, | C5 (−d_{c1}, |
| Center | dᵣ₂/2, −d/2) | 0, −d/2) | d/2) | 0, d/2) | dᵣ₁/2, d/2) |
| nₛₚₒₜₛ | 2 × n₁ | 2 × n₁ | 2 × n₂ − 2 | 1 | 1 |
| nᵣₑ | n₂ − 1 | n₂ | 2 × n₁ | n₁ | n₁ + 1 |
| Point of | (−d_{c1} × 1.5, dᵣ₁ × (n₁ + 1)/2, d/2) | | | | |
| Incidence | | | | | |
| “in” | | | | | |
| Aiming | (d_{c2}/2, −dᵣ₂ × (n₂ − 1)/2, −d/2) | | | | |
| Point | | | | | |
| “aim” | | | | | |
| Point of | (−d_{c1}/2, dᵣ₁ × (n₁ + 1)/2, d/2) | | | | |
| Emergence | | | | | |
| “out” | | | | | |

| | |
|---|---|
| Number of | [2 × (2 × n₂ − 1)] × (2 × n₁) + 2 |
| Passes N_{PP} | |
| Optical Path | N_{PP} × d |
| opl | |

It should also be noted that stability of the optical path of the multi-pass cells is the main factor that restricts its performance in the actual measurement and long-term reliability. In practical applications, interference from the external environment may have a certain impact on the optical path. For example, factors such as vibrations at the production site may cause slight changes in the direction of the incident light. Local deformation of cells caused by the changes in temperature in natural environment may cause deviations in curvature center of spherical mirror. The multi-pass cells based on PBWC-PBWC in the present invention have a typical structure of confocal resonator, which has the following two main advantages: 1) The optical path is insensitive to the angle of the incident light. Specifically, aiming point “aim” is located on the fifth spherical mirror M5. A slight deviation in the position of the aiming point will only affect spatial position of the two columns of light spots on the third spherical mirror M3, the fourth spherical mirror M4 and the fifth spherical mirror M5 on aiming side and has almost no effect on the position of emergent light spots and its measurement. As a result, optical path adjustment is extremely simple and is insensitive to slight disturbances in direction of incident light caused by environmental factors. In addition, the larger the spacing of light spot rows on the aiming side, the less sensitive the optical path is to the angle of incident light. 2) The beam quality is good, and deformation of light spots is small. Specifically, in the multi-pass cells provided by embodiment of the present invention, curvature radius of each spherical mirror is 1,000 mm, and cells with long optical path strictly satisfy condition of paraxial approximation. The four columns of light spots on the incident side comprise the light spot of point of emergence “out”, which are all perfect mirror images of the light spot of point of incidence “in”, and two columns of light spots on aiming side are perfect mirror images of the light spot of aiming point “aim”. The shape as well as size of the light spots on both sides can be adjusted by adjusting collimation degree of incident light, which has advantages of small deformation of light spots and good beam quality.

In addition, the position deviation of curvature center is an important factor affecting the performance of the multi-pass cells based on PBWC-PBWC. Since the five spherical mirrors have different functions in the PBWC components, they have different sensitivities to disturbances from environmental factors such as the temperature and the vibration. The first spherical mirror M1 and the second spherical mirror M2 are objective mirrors of first PBWC component (PBWC-a). Their curvature centers C1 and C2 are located on the field mirror M3 of first PBWC component (PBWC-a). The function of curvature centers C1 and C2 is to form two columns of light spots of the classic PBWC component on aiming side, and distance between curvature centers C1 and C2 determines the spacing of light spot rows on aiming side. In practical applications, the adjusted first spherical mirror M1 and the second spherical mirror M2 can be fixed as whole to ensure that the spacing of light spot rows on the aiming side remains unchanged. The overall offset or deflection of the spatial position of curvature centers C1 and C2 in x-direction and y-direction will cause the synchronous offset or deflection of the two columns of light spots on the aiming side. During offset or deflection process, if there is no light spot which is emergent from mirror or hitting the interface of spherical mirror, it will not have a great impact on the position of the emergent light spot, and will not affect use of the cells, thus showing excellent stability. The third spherical mirror M3 is the field mirror of first PBWC component (PBWC-a), and its curvature center C3 is located at the center position of objective mirrors M1 and M2 of PBWC-b on incident side. Its function is to realize mirror mapping of the light spots on M2 on M1, and it shows the best stability in the x- and y-directions. The offset of the spatial position of the curvature center C3 mainly affects the spatial position of mirror light spot on M1. In the case that light spot does not emerge from mirror or hit the interface of spherical mirror, position of emergent light is almost not affected by initial disturbance. The fourth spherical mirror M4 and the fifth spherical mirror M5 are objective mirrors of the second PBWC component (PBWC-b), and their curvature centers C4 as well as C5 are located on field mirror M2 of the second PBWC component (PBWC-b) on incident side. Since emergent light spot of cells “out” is located at the emergent position of PBWC-a, position offset or deflection of the curvature centers C4 and C5 will directly lead to offset or deflection of position of the emergent light spot, and offset amount is positively correlated with the number of reflections. The curvature centers C4 as well as C5 are most sensitive to disturbances in x-direction and y-direction caused by the environment. Therefore, in order to reduce impact of position deviation of the curvature center on the cells, after completing optical path adjustment, first spherical mirror M1 and second spherical mirror M2 on incident side can be fixed as whole, and third spherical mirror M3, fourth spherical mirror M4 as well as fifth spherical mirror M5 on aiming side can be fixed as whole to ensure that curvature centers on the both sides change synchronously, and optical mirror mounts with excellent structural stability as well as good adjustability can be adopted to improve stability and reliability of the multi-pass cells in practical applications.

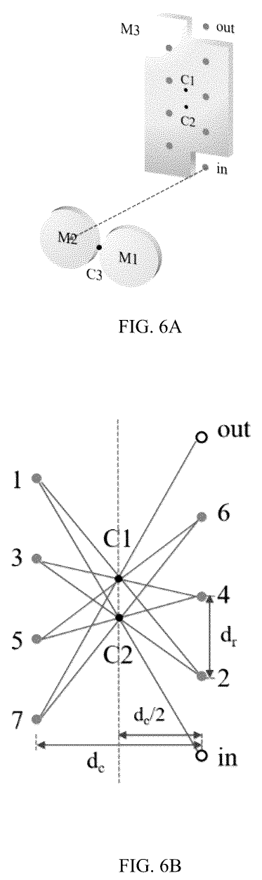

FIG. 6A and FIG. 6B are respectively a schematic diagram showing structure of existing classic BHWC component and a schematic diagram showing pattern of light spot formed on field mirror.

As shown in FIG. 6A and FIG. 6B, classic BHWC component is also composed of three concave spherical mirrors with equal curvature radii, among which the spherical mirror on incident side is a rectangular field mirror M3 with two notches, and the positions of the two notches correspond to the incident position and the emergent position respectively, and the aiming side has two circular objective mirrors M1 and M2. The reflection law of classic BHWC component is basically the same as that of classic PBWC component, and two rows of cross-arranged light spots will eventually be obtained on field mirror M3, and light spots are distributed in a trapezoidal shape. The total number of light spots is 2×n_{BHWC}−1, wherein n_{BHWC} represents the number of light spots on the short bottom side of trapezoid, and wherein number of reuses of each light spot's spatial position is 1. In FIG. 6, the first and second rows of light spot on the field mirror M3 are focused respectively by objective mirrors M2 and M1. The number of light spots on objective mirrors M1 and M2 is 1, and the number of reuses of light spot's spatial position on the objective mirrors M1 and M2 is n_{BHWC}. The number of passes of classic BHWC component N_{BHWC} is calculated as:

$${N}_{BHWC} = 2 \times ( 2 \times {n}_{BHWC} ) .$$

What needs to be pointed out is that the mirror utilization rate of each spherical mirror in classic BHWC component and number of reuses of light spot's spatial position have same defects as classic PBWC component. Therefore, classic BHWC component is also suitable for designing strategy of the bilateral field mirror. Unlike the adjacent positions of point of incidence and point of emergence of classic PBWC component, point of incidence and point of emergence of classic BHWC component are located at both ends of field mirror, which can provide more installation space for TDLAS laser emitting as well as receiving devices.

In several embodiments, any one or both of first circulation component as well as second circulation component may also be BHWC component. Specifically, first circulation component and second circulation component may respectively be BHWC component and PBWC component, so that multi-pass cells based on BHWC-PBWC may be obtained. First circulation component and second circulation component may also be PBWC component and BHWC component respectively, so that the multi-pass cells based on PBWC-BHWC may be obtained. In addition, first circulation component and second circulation component may respectively be a BHWC component, so that multi-pass cells based on BHWC-BHWC may be obtained. It should be noted that multi-pass cells based on BHWC-PBWC, multi-pass cells based on PBWC-BHWC, and multi-pass cells based on BHWC-BHWC all use five spherical mirrors (for example, rectangular concave spherical mirrors), and the incident-side mirror comprises 2 spherical mirrors, and the aiming-side mirror comprises 3 spherical mirrors. Specifically, incident-side mirror includes first spherical mirror M1 as well as second spherical mirror M2 spliced to each other, and aiming-side mirror includes third spherical mirror M3, fourth spherical mirror M4 as well as fifth spherical mirror M5 spliced to each other. The mirror spacing d between incident-side mirror and aiming-side mirror is equal to the curvature radius of each spherical mirror, and above-mentioned reflection law is also applicable (each time the light undergoes a complete reflection process on the first circulation component, it will undergo a step of reflection on the second circulation component and form a new light spot on the field mirror M2 of second circulation component), and is applicable to the formula for calculating total number of passes and optical path.

It should be noted that the number of rows of light spots formed by light on incident-side mirror is represented as n₁, the spacing between the rows of light spots on the incident-side mirror is represented as dᵣ₁, and the spacing between the columns of light spots on the incident-side mirror is represented as d_{c1}. The number of rows of light spots formed by light on the aiming-side mirror is represented as n₂, the spacing between rows of light spots on aiming-side mirror is represented as dᵣ₂, and the spacing between columns of light spots on aiming-side mirror is represented as d_{c2}.

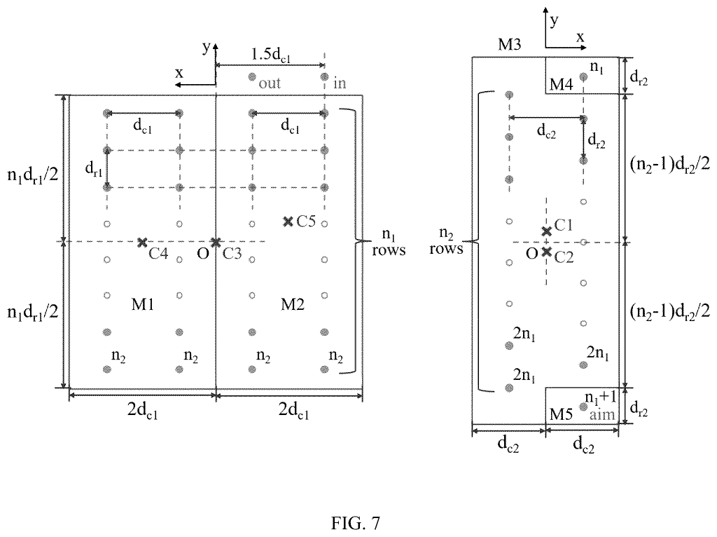

FIG. 7 is a schematic diagram showing positional relationship between light spots formed on mirror on both sides of multi-pass cells based on BHWC-PBWC and curvature center of each spherical mirror according to embodiment of the present invention.

As shown in FIG. 7, in some embodiments, the first circulation component as well as the second circulation component may be BHWC component and PBWC component respectively, so that multi-pass cells based on BHWC-PBWC can be obtained.

Specifically, in the multi-pass cells based on the BHWC-PBWC, the third spherical mirror M3 is rectangular concave spherical mirror with two upper and lower notches.

The first spherical mirror M1, the second spherical mirror M2, the fourth spherical mirror M4 and the fifth spherical mirror M5 are all rectangular concave spherical mirrors, and the fourth spherical mirror M4 as well as the fifth spherical mirror M5 are all arranged (embedded) at two notches of the third spherical mirror M3, filling one notch respectively. In this way, the projection shape of incident-side mirror composed of first spherical mirror M1 and second spherical mirror M2 (projection shape along z-axis direction) is rectangle, and projection shape of the aiming-side mirror composed of third spherical mirror M3, fourth spherical mirror M4 as well as fifth spherical mirror M5 (projection shape along z-axis direction) is rectangle.

In the present embodiment, light can be incident from point of incidence above the second spherical mirror M2 and aimed at the geometric center of the fifth spherical mirror M5, and after the incident light is reflected at multiple times between incident-side mirror and aiming-side mirror, it can be emergent from the point of emergence “out” above the second spherical mirror M2 that is horizontally adjacent to the point of incidence “in”.

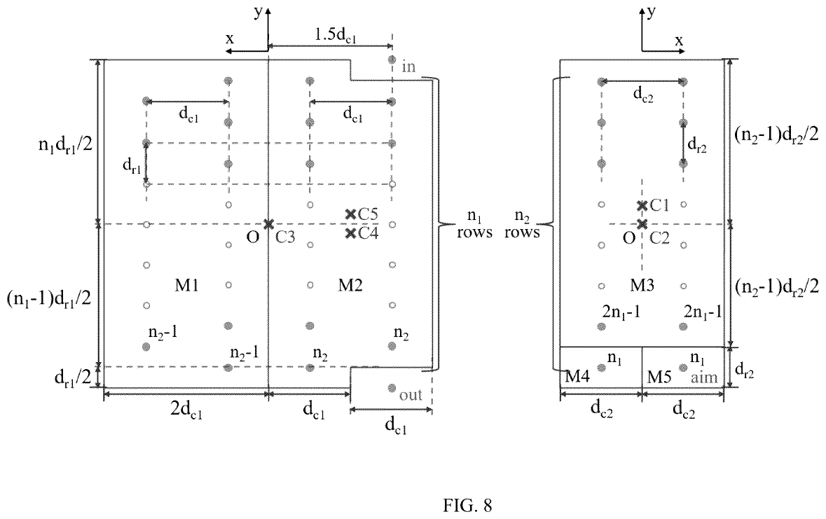

FIG. 8 is a schematic diagram showing positional relationship between light spots formed on mirror on both sides of multi-pass cells based on PBWC-BHWC and curvature center of each spherical mirror according to embodiment of the present invention.

As shown in FIG. 8, in some embodiments, the first circulation component and the second circulation component may be PBWC component and BHWC component respectively, so that the multi-pass cells based on PBWC-BHWC may be obtained.

Specifically, in the multi-pass cells based on PBWC-BHWC, the second spherical mirror M2 is rectangular concave spherical mirror with two upper and lower notches.

The first spherical mirror M1, the third spherical mirror M3, the fourth spherical mirror M4 and the fifth spherical mirror M5 are all rectangular concave spherical mirrors, and projection shape of the aiming-side mirror is rectangle. Among them, the fourth spherical mirror M4 and the fifth spherical mirror M5 have same size and are arranged side by side below third spherical mirror M3 on aiming side, spliced with the bottom end of third spherical mirror M3. In addition, sum of the widths of the fourth spherical mirror M4 and the fifth spherical mirror M5 is equal to the width of the third spherical mirror M3, so that the projection shape of the aiming-side mirror (projection shape along z-axis direction) composed of third spherical mirror M3, fourth spherical mirror M4 and fifth spherical mirror M5 is rectangular. The first spherical mirror M1 and the second spherical mirror M2 are spliced with each other along the x-axis direction.

In the present embodiment, light can be incident from point of incidence “in” at the notch above the second spherical mirror M2 and aimed at geometric center of the fifth spherical mirror M5. In addition, incident light can be reflected at multiple times between incident-side mirror and aiming-side mirror and then emergent from point of emergence “out” at the notch below the second spherical mirror M2.

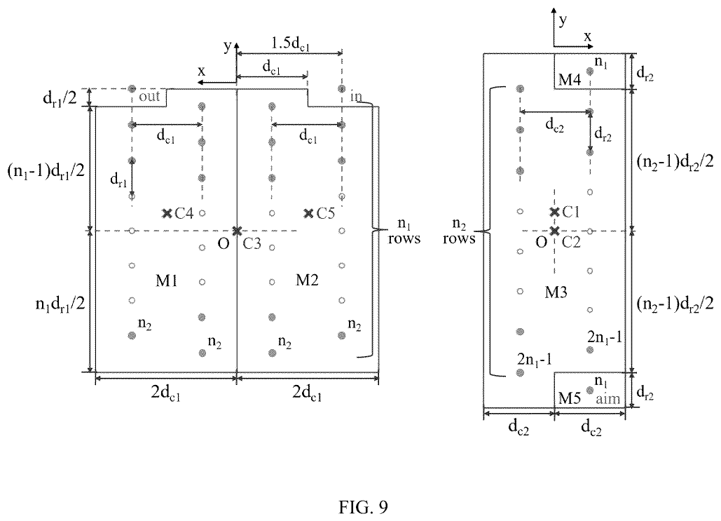

FIG. 9 is a schematic diagram showing positional relationship between light spots formed on the mirror on both sides of the multi-pass cells based on BHWC-BHWC and curvature center of each spherical mirror according to embodiment of the present invention.

As shown in FIG. 9, in some embodiments, the first circulation component and the second circulation component may be a BHWC component respectively, so that multi-pass cells based on BHWC-BHWC can be obtained.

Specifically, in multi-pass cells based on BHWC-BHWC, first spherical mirror M1 and second spherical mirror M2 are respectively rectangular concave spherical mirrors with a notch on the top, first spherical mirror M1 and second spherical mirror M2 are spliced with each other along the x-axis direction and are symmetrical with respect to the y-axis. The third spherical mirror M3 is a rectangular concave spherical mirror with two notches on the top and the bottom.

The fourth spherical mirror M4 as well as fifth spherical mirror M5 are both rectangular concave spherical mirrors, and the fourth spherical mirror M4 as well as the fifth spherical mirror M5 are arranged at the two notches of the third spherical mirror M3. In this way, projection shape (projection shape along z-axis direction) of aiming-side mirror formed by splicing third spherical mirror M3, fourth spherical mirror M4 and fifth spherical mirror M5 is rectangle.

In the present embodiment, light can be incident from the incident point “in” at the notch of the second spherical mirror M2 and aimed at geometric center of the fifth spherical mirror M5, and incident light can be emergent from point of emergence “out” at the notch of the first spherical mirror M1 after multiple reflections between the incident-side mirror and the aiming-side mirror.

As shown in FIGS. 7 to 9, in the multi-pass cells based on BHWC-PBWC, PBWC-BHWC and BHWC-BHWC, the first curvature center C1 of first spherical mirror M1 as well as the second curvature center C2 of second spherical mirror M2 are located on the aiming-side mirror. The third curvature center C3 of third spherical mirror M3, the fourth curvature center C4 of fourth spherical mirror M4, and the fifth curvature center C5 of fifth spherical mirror M5 are located on incident-side mirror. The incident point “in” is located on one side (above) of second spherical mirror M2, and aiming point “aim” is located at geometric center of fifth spherical mirror M5.

Referring to the mirror coordinate axis shown in FIGS. 7 to 9, and to the various parameters of multi-pass cells based on BHWC-PBWC, PBWC-BHWC and BHWC-BHWC shown in Table 2 below, first circulation component corresponds to small circulation which is represented as a cell, and second circulation component corresponds to large circulation which is represented as b cell. nₛₚₒₜₛ represents the number of light spots on each spherical mirror, nᵣₑ represents number of reuses of light spot's spatial position on each spherical mirror, and d represents mirror spacing between the incident-side mirror and the aiming-side mirror. N_{BP} represents the number of passes of multi-pass cells based on BHWC-PBWC, N_{PB} represents number of passes of the multi-pass cells based on PBWC-BHWC, and N_{BB} represents number of passes of the multi-pass cells based on BHWC-BHWC.

TABLE 2
Parameters of the multi-pass cells based on BHWC-PBWC, PBWC-BHWC and BHWC-BHWC

| | Multi-pass cells based on | | Multi-pass cells based on | | Multi-pass cells based on | |
|---|---|---|---|---|---|---|
| Parameters | BHWC-PBWC | | PBWC-BHWC | | BHWC-BHWC | |
| a cell | BHWC | M3-M1M2 | PBWC | M3-M1M2 | BHWC | M3-M1M2 |
| b cell | PBWC | M2-M4M5 | BHWC | M2-M4M5 | BHWC | M2-M4M5 |
| M1 | nₛₚₒₜₛ | 2 × n₁ | nₛₚₒₜₛ | 2 × n₁ − 1 | nₛₚₒₜₛ | 2 × n₁ − 1 |
| | nᵣₑ | n₂ | nᵣₑ | n₂ − 1 | nᵣₑ | n₂ |
| M2 | nₛₚₒₜₛ | 2 × n₁ | nₛₚₒₜₛ | 2 × n₁ − 1 | nₛₚₒₜₛ | 2 × n₁ − 1 |
| | nᵣₑ | n₂ | nᵣₑ | n₂ | nᵣₑ | n₂ |
| M3 | nₛₚₒₜₛ | 2 × n₂ − 1 | nₛₚₒₜₛ | 2 × n₂ − 2 | nₛₚₒₜₛ | 2 × n₂ − 1 |
| | nᵣₑ | 2 × n₁ | nᵣₑ | 2 × n₁ − 1 | nᵣₑ | 2 × n₁ − 1 |
| M4 | nₛₚₒₜₛ | 1 | nₛₚₒₜₛ | 1 | nₛₚₒₜₛ | 1 |
| | nᵣₑ | n₁ | nᵣₑ | n₁ | nᵣₑ | n₁ |
| M5 | nₛₚₒₜₛ | 1 | nₛₚₒₜₛ | 1 | nₛₚₒₜₛ | 1 |
| | nᵣₑ | n₁ + 1 | nᵣₑ | n₁ | nᵣₑ | n₁ |

| | | | |
|---|---|---|---|
| C1 | (0, dᵣ₂/4, −d/2) | (0, dᵣ₂/2, −d/2) | (0, dᵣ₂/4, −d/2) |
| C2 | (0, −dᵣ₂/4, −d/2) | (0, 0, −d/2) | (0, −dᵣ₂/4, −d/2) |
| C3 | (0, 0, d/2) | (0, 0, d/2) | (0, 0, d/2) |
| C4 | (d_{c1}, 0, d/2) | (−d_{c1}, −dᵣ₁/4, d/2) | (d_{c1}, dᵣ₁/4, d/2) |
| C5 | (−d_{c1}, dᵣ₁/2, d/2) | (−d_{c1}, dᵣ₁/4, d/2) | (−d_{c1}, dᵣ₁/4, d/2) |
| Point of | (−d_{c1} × 1.5, dᵣ₁ × (n₁ + 1)/2, d/2) | (−d_{c1} × 1.5, dᵣ₁ × n₁/2, d/2) | (−d_{c1} × 1.5, dᵣ₁ × n₁/2, d/2) |
| Incidence | | | |
| “in” | | | |
| Aiming | (d_{c2}/2, −dᵣ₂ × n₂/2, −d/2) | (d_{c2}/2, −dᵣ₂ × (n₂ − 1)/2, −d/2) | (d_{c2}/2, −dᵣ₂ × n₂/2, −d/2) |
| Point “aim” | | | |
| Point of | (−d_{c1}/2, dᵣ₁ × (n₁ + 1)/2, d/2) | (−d_{c1} × 1.5, −dᵣ₁ × n₁/2, d/2) | (d_{c1} × 1.5, dᵣ₁ × n₁/2, d/2) |
| Emergence | | | |
| “out” | | | |
| Number of | N_{BP} = [2 × (2 × n₂)] × | N_{PB} = [2 × (2 × n₂ − 1)] × | N_{BB} = [2 × (2 × n₂)] × |
| Passes N | (2 × n₁) + 2 | (2 × n₁ − 1) + 2 | (2 × n₁ − 1) + 2 |
| Optical Path | N_{BP} × d | N_{PB} × d | N_{BB} × d |
| opl | | | |

The multi-pass cells based on PBWC-PBWC, BHWC-PBWC, PBWC-BHWC as well as BHWC-BHWC provided according to above embodiments of the present invention are all based on two-fold cyclic reflection mode and consist of two circulation components.

In the embodiment of the present invention, the multi-pass cells based on two circulation components can be expanded to three or more circulation components.

Specifically, in the embodiment of the present invention, the multi-pass cells may include incident-side mirror as well as aiming-side mirror arranged relatively on both sides, and incident-side mirror as well as aiming-side mirror respectively comprise a plurality of the spherical mirrors (rectangular concave spherical mirrors) spliced to each other. Among them, a total of n circulation components are formed based on incident-side mirror as well as aiming-side mirror. Any of the n circulation components includes field mirror and objective mirror arranged relatively on the both sides, that is, any circulation component may be matrix-type multi-pass cells possessing characteristics of “one side is field mirror, and the other side is objective mirror”. The present invention does not limit specific type of circulation component, if it meets characteristics of “one side is field mirror, and the other side is objective mirror”. Here, n can be a positive integer greater than or equal to 2.

The light can be incident from the point of incidence on one side of the field mirror of one of the circulation components (hereinafter referred to as “the circulation component”) and aimed at geometric center of objective mirror of present circulation component (present geometric center is current aiming point). After the light undergoes n-fold cyclic reflection between the incident-side mirror and the aiming-side mirror (wherein each cyclic reflection includes multiple reflections), it can be emergent from the point of emergence on one side of field mirror of the circulation component and finally forms multiple rows and columns of the light spots on aiming-side mirror and incident-side mirror respectively.

It can be understood that the above-mentioned multi-pass cells are also “multi-pass cells with n-fold circulation”. In multi-pass cells with n-fold circulation, the point of incidence and the point of emergence are respectively located on one side of the field mirror of one of the circulation components.

In the embodiment of the present invention, under the premise that n is a positive integer greater than or equal to 2, for any multi-pass cells with n-fold circulation, taking geometric center of objective mirror of one of the circulation components (“the circulation component”) as the original aiming point, a new circulation component can be added on the basis of multi-pass cells with n-fold circulation to form multi-pass cells with (n+1)-fold circulation in following manner: by adding a first new spherical mirror and a second new spherical mirror respectively at the positions of point of incidence and point of emergence on one side of the field mirror of one of circulation components (“the circulation component”) (or, respectively adding first new spherical mirror and second new spherical mirror at the positions of above-mentioned point of emergence and point of incidence), a new circulation component can be formed based on the spherical mirror at original aiming point, first new spherical mirror as well as second new spherical mirror, and the spherical mirror at the original aiming point serves as field mirror of the new circulation component, and first new spherical mirror as well as second new spherical mirror serve as objective mirror of new circulation component. In this way, a new circulation component is formed on the basis of multi-pass cells with the n-fold circulation, and on the basis of adding two new spherical mirrors to original incident-side mirror, a total of n+1 circulation components are formed based on original incident-side mirror (including the added first new spherical mirror and second new spherical mirror) as well as original aiming-side mirror to obtain the multi-pass cells with (n+1)-fold circulation.

It is worth noting that it is sufficient to add two new spherical mirrors at point of incidence and point of emergence on one side of field mirror of one of above-mentioned circulation components (“the circulation component”). In the embodiment of the present invention, to facilitate distinction, two new spherical mirrors are respectively named as the first new spherical mirror and the second new spherical mirror.

Based on the above multi-pass cells with (n+1)-fold circulation, light can be incident from new point of incidence on one side of field mirror of new circulation component (i.e., spherical mirror where the original aiming point is located) and aim at geometric center of first new spherical mirror or second new spherical mirror (i.e., any objective mirror of new circulation component as the new aiming point), and after light undergoes (n+1)-fold cyclic reflection between incident-side mirror and aiming-side mirror, it can be emergent from new point of emergence on one side of field mirror of new circulation component, and finally forms multiple rows and columns of the light spots on aiming-side mirror as well as incident-side mirror respectively. It can be understood that in multi-pass cells with (n+1)-fold circulation, the new point of incidence, and the new point of emergence are respectively located on one side of field mirror of the new circulation component.

It should be noted that, in the embodiments of the present invention, types of circulation components may include PBWC components, BHWC components and Chernin matrix-type multi-pass cells, but are not limited to these three types. Circulation component in present invention may be any matrix-type multi-pass cells having characteristics of “one side is field mirror, and the other side is objective mirror”.

Taking the two-fold multi-pass cells based on the PBWC-PBWC as an example, it can be expanded into three-fold multi-pass cells based on PBWC-PBWC-PBWC by the following method: two new spherical mirrors (rectangular concave spherical mirrors) are respectively added at current point of emergence “out” and point of incidence “in” of original multi-pass cells based on PBWC-PBWC, which are the sixth spherical mirror M6 (corresponding to above-mentioned “second new spherical mirror”) and the seventh spherical mirror M7 (corresponding to above-mentioned “first new spherical mirror”). In this way, the fifth spherical mirror M5, the sixth spherical mirror M6 as well as the seventh spherical mirror M7 based on original aiming point (original aiming point of two-fold multi-pass cells based on PBWC-PBWC) can form new circulation component (third circulation component PBWC-c), and sixth spherical mirror M6 as well as seventh spherical mirror M7 serve as the both objective mirrors of new circulation component (third circulation component PBWC-c), and the fifth spherical mirror M5 serves as field mirror of the new circulation component (third circulation component PBWC-c). In this way, a new circulation component (third circulation component PBWC-c) is formed based on the multi-pass cells of the PBWC-PBWC with two-fold circulation, and two new spherical mirrors are added to the original incident-side mirror. Based on original incident-side mirror (including the added sixth spherical mirror M6 as well as the seventh spherical mirror M7) as well as original aiming-side mirror, a total of three circulation components (PBWC) are formed to obtain the three-fold multi-pass cells based on PBWC-PBWC-PBWC.

Furthermore, the sixth curvature center C6 of sixth spherical mirror M6 can be adjusted to the center position of the fifth spherical mirror M5, the seventh curvature center C7 of seventh spherical mirror M7 can be adjusted to right side of C6 on fifth spherical mirror M5, incident light is adjusted to right side of the fifth spherical mirror M5, and the center position of seventh spherical mirror M7 serves as the aiming point. Accordingly, three-fold multi-pass cells based on PBWC-PBWC-PBWC can be constructed.

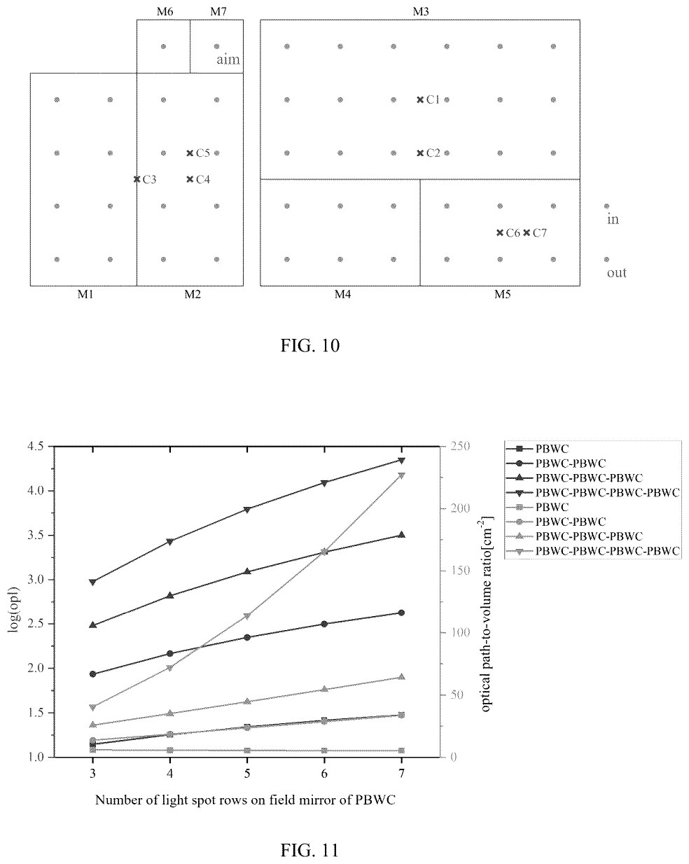

By adopting the above method, the multi-pass cells based on PBWC-PBWC with a pass number of 114 can be expanded into multi-pass cells based on PBWC-PBWC-PBWC with a pass number of 398. FIG. 10 is a schematic diagram showing pattern of light spots formed on the mirror on both sides of multi-pass cells based on PBWC-PBWC-PBWC according to embodiment of the present invention.

FIG. 11 is a line graph showing optical path and optical path-to-volume ratio of the n-fold circulation multi-pass cells with different numbers of light spot rows on field mirror of PBWC. As shown in FIG. 11, by increasing the number of circulation components and the number of passes of the circulation components, optical path as well as optical path-to-volume ratio of the cells can be significantly improved.

In summary, multi-pass cells provided according to embodiment of the present invention comprises incident-side mirrors as well as aiming-side mirrors arranged relatively on both sides. The incident-side mirror and aiming-side mirror respectively comprise a plurality of the spherical mirrors spliced to each other, wherein a plurality of circulation components are formed based on incident-side mirrors and aiming-side mirrors, and any circulation component comprises field mirror as well as objective mirror arranged relatively on both sides, and light can be incident from point of incidence on one side of field mirror of one of the circulation components and aim at the geometric center of objective mirror of the present circulation component, and after multi-fold cyclic reflections between incident-side mirror and aiming-side mirror, it is emergent from the point of emergence on one side of field mirror of the circulation component, and finally multiple rows and columns of light spots are formed on the aiming-side mirror and the incident-side mirror respectively. It can be seen that the multi-pass cells of the present invention have the simple structure and can achieve synchronous improvement in the utilization rate of bilateral mirrors and number of reuses of light spot's spatial position, thereby improving optical path, and further improving the detection accuracy and stability of the multi-pass cells for trace gases.

Further, according to the technical solution of the present invention, by adding two new spherical mirrors at the point of incidence and the point of emergence on one side of the field mirror of one of circulation components, new circulation component can be formed based on the spherical mirror at original aiming point, the first new spherical mirror and the second new spherical mirror, and spherical mirror at original aiming point serves as field mirror of the new circulation component, and the two new spherical mirrors serve respectively as the objective mirrors of the new circulation component, thereby obtaining the multi-pass cells with more multi-fold circulation. By increasing number of circulation components, optical path and optical path-to-volume ratio of multi-pass cells can be further improved.

In the disclosure of the present invention, unless explicitly stated and limited, otherwise the terms “connected”, “fixed”, etc. should be interpreted broadly. In addition, the orientations or the positional relationships indicated by terms such as “front”, “back”, “upper”, “lower”, “internal”, “external”, “top” and “bottom” are based on the orientations or positional relationships indicated by accompanying drawings of the present invention. These orientations or positional relationships are used only to facilitate describing the present invention and simplifying the descriptions rather than indicate or imply that devices or elements indicated herein must have a particular orientation or are constructed and operated in a particular orientation and thus cannot be understood as limiting of the present invention.

In the description provided herein, many specific details are described to fully understand disclosure, but the present disclosure may also be implemented in other ways different from those described here. In some instances, well-known methods, structures and technologies have not been described in detail as not to unnecessarily obscure aspects of the present disclosure.

It should be understood that in order to simplify the present invention and help understand one or more of the various inventive aspects, in the above description of example embodiments of the present invention, various features of the present invention are sometimes grouped together into a single embodiment, drawing, or description thereof. However, the disclosed method should not be interpreted as reflecting the intention that the claimed invention claims more features than those explicitly recited in each claim. More specifically, as reflected by following claims, inventive aspects can lie in fewer than all features of a single foregoing disclosed embodiment. Therefore, the claims that follow a specific implementation are hereby expressly incorporated into the specific implementation, where each claim itself serves as a separate embodiment of the present invention.

Those skilled in the art should understand that the modules or units or components of the device in examples disclosed herein may be arranged in the device as described in this embodiment, or alternatively may be positioned in one or more devices different from the device in this example. The modules in the foregoing examples may be combined into one module or, in addition, may be divided into multiple sub-modules.

Those skilled in the art can understand that the modules in the device in the embodiment can be adaptively changed and set in one or more devices different from this embodiment. Modules or units or components in the embodiment may be combined into one module or unit or component, and in addition, they may be divided into a plurality of submodules or subunits or subcomponents.

What is claimed is:

1. The multi-pass cells, which comprise an incident-side mirror as well as an aiming-side mirror arranged relatively on both sides, wherein incident-side mirror and aiming-side mirror respectively comprise a plurality of spherical mirrors spliced to each other, wherein
a total of n circulation components is formed based on incident-side mirror and aiming-side mirror, wherein any of circulation components comprises a field mirror as well as an objective mirror arranged relatively on both sides, wherein n is a positive integer greater than or equal to 2, wherein
light is suitable for being incident from the point of incidence on one side of the field mirror of one of the circulation components and aiming at the geometric center of an single objective mirror of the present circulation component, wherein light is also suitable for being emergent from the point of emergence on one side of the field mirror of the circulation components after n-fold cyclic reflection between incident-side mirror and aiming-side mirror, and wherein the multiple rows and columns of light spots respectively on aiming-side mirror and incident-side mirror are finally formed, and wherein
the incident-side mirror comprises a first spherical mirror and a second spherical mirror spliced to each other, wherein the aiming-side mirror comprises a third spherical mirror, a fourth spherical mirror as well as a fifth spherical mirror spliced to each other, wherein
a first circulation component is formed based on the third spherical mirror, the first spherical mirror as well as the second spherical mirror, wherein the third spherical mirror serves as field mirror of the first circulation component, wherein the first spherical mirror and the second spherical mirror serve as objective mirrors of the first circulation component respectively, wherein the second circulation component is formed based on the second spherical mirror, the fourth spherical mirror and the fifth spherical mirror, wherein the second spherical mirror serves as field mirror of the second circulation component, wherein the fourth spherical mirror and the fifth spherical mirror respectively serve as the objective mirror of second circulation component, wherein
light is suitable for being incident from point of incidence on one side of second spherical mirror and aiming at geometric center of the fifth spherical mirror, wherein light is also suitable for being emergent from point of emergence on one side of the second spherical mirror after two-fold cyclic reflection between aiming-side mirror and incident-side mirror, wherein each time light undergoes a complete reflection process on the first circulation component, it undergoes a step of reflection on second circulation component and forms a light spot on the field mirror of the second circulation component, and wherein two columns of light spots are formed on the aiming-side mirror and four columns of light spots are formed on the incident-side mirror.

2. The multi-pass cells according to claim 1, wherein geometric center of an objective mirror of the present circulation component serves as the original aiming point, wherein
a new circulation component can be formed based on the spherical mirror at original aiming point, the first new spherical mirror and the second new spherical mirror by additionally setting first new spherical mirror and second new spherical mirror at the positions of incident point and emergent point on the side of field mirror of one of the circulation components, wherein the spherical mirror at the original aiming point serves as the field mirror of the new circulation component, while first new spherical mirror and second new spherical mirror serves respectively as the objective mirror of the new circulation component, wherein
light is suitable for being incident from the new point of incidence on one side of the field mirror of the new circulation component and aiming at geometric center of the first new spherical mirror or the second new spherical mirror, wherein light is also suitable for being emergent from new point of emergence on one side of the field mirror of the new circulation component after (n+1)-fold cyclic reflection between aiming-side mirror and incident-side mirror, and wherein the multiple rows and columns of light spots respectively on aiming-side mirror as well as incident-side mirror are finally formed.

3. The multi-pass cells according to claim 1, wherein types of circulation components comprise Pickett Bradley White cell (PBWC) component, Bernstein Herzberg White cell (BHWC) component as well as Chernin multi-pass matrix system.

4. The multi-pass cells according to claim 1, wherein
curvature radii of the first spherical mirror, the second spherical mirror, the third spherical mirror, the fourth spherical mirror and the fifth spherical mirror are equal, and wherein the mirror spacing between incident-side mirror and aiming-side mirror is equal to the curvature radius.

5. The multi-pass cells according to claim 1, wherein first circulation component and second circulation component are respectively PBWC component or BHWC component.

6. The multi-pass cells according to claim 5, wherein first circulation component as well as second circulation component are respectively a PBWC component, wherein
first spherical mirror, second spherical mirror, third spherical mirror, fourth spherical mirror and fifth spherical mirror are all rectangular concave spherical mirrors, wherein the projection shapes of incident-side mirror and aiming-side mirror are both rectangular, and wherein
each-cycle reflection comprises multiple reflections respectively.

7. The multi-pass cells according to claim 6, wherein the first curvature center of the first spherical mirror is located at geometric center of the third spherical mirror, wherein
the second curvature center of second spherical mirror is located directly below the first curvature center, wherein
the third curvature center of the third spherical mirror is located at center position on the dividing line between the first spherical mirror and the second spherical mirror, wherein
the fourth curvature center of the fourth spherical mirror is located at geometric center of second spherical mirror and is on same horizontal line as the third curvature center, and wherein the fifth curvature center of the fifth spherical mirror is located directly above the fourth curvature center.

8. The multi-pass cells according to claim 1, wherein
it is suitable for forming a plurality of the continuous light spots on the first circulation component whenever light undergoes a complete reflection process on the first circulation component.

9. The multi-pass cells according to claim 8, wherein a plurality of the continuous light spots are formed on first circulation component, wherein
a light spot sequence is sequentially formed on field mirror of first circulation component, wherein the light spot sequence comprises a third number of light spots, wherein
a second number of light spots are overlapped at the identical position on second spherical mirror of the first circulation component, wherein the second number is used to represent the number of reuses of each light spot's spatial location on the second spherical mirror, wherein
a first number of light spots are overlapped at the identical position on first spherical mirror of first circulation component, and wherein the first number is used to represent number of reuses of each light spot's spatial location on the first spherical mirror.

10. The multi-pass cells according to claim 9, wherein
it is suitable for forming the continuous 2×(2×n₂−1) light spots on the first circulation component whenever light undergoes a complete reflection process on first circulation component, wherein
n₂ represents number of light spot rows formed by the light on aiming-side mirror, wherein
it is suitable for forming the first to the 2×(2×n₂−1)^{th} light spots on the first circulation component whenever light undergoes the first complete reflection process on the first circulation component, wherein
the first number is n₂−1 and wherein the second number is n₂.

11. The multi-pass cells according to claim 10, wherein
the number of complete reflection processes performed by light on first circulation component is equal to number of light spots formed on the field mirror of the second circulation component 2×n₁, wherein n₁ represents the number of rows of light spots formed on the incident-side mirror by the light, wherein
number of reuses of each light spot's spatial location on field mirror of the first circulation component is equal to number of the complete reflection processes performed by light on the first circulation component 2×n₁.

12. The multi-pass cells according to claim 11, wherein
the total number of passes of the multi-pass cells is calculated as N_{PP}=[2×(2×n₂−1)]×(2×n₁)+2, wherein n₁ and n₂ are both positive integers, wherein
optical path of the multi-pass cells is calculated as opl=N_{PP}×d, and wherein d represents mirror spacing between the incident-side mirror and the aiming-side mirror.

13. The multi-pass cells according to claim 1, wherein
distance between first curvature center of the first spherical mirror and second curvature center of the second spherical mirror is dᵣ₂/2, wherein dᵣ₂ represents the spacing between light spot rows on aiming-side mirror, wherein
distance between fourth curvature center of the fourth spherical mirror and fifth curvature center of the fifth spherical mirror is dᵣ₁/2, and wherein dᵣ₁ represents the spacing between light spot rows on incident-side mirror.

14. The multi-pass cells according to claim 5, wherein the first circulation component as well as second circulation component are respectively BHWC component as well as PBWC component, wherein
the third spherical mirror is rectangular concave spherical mirror with two upper and lower notches, wherein
first spherical mirror, second spherical mirror, fourth spherical mirror and fifth spherical mirror are all rectangular concave spherical mirrors and fourth spherical mirror as well as fifth spherical mirror are arranged at the two notches of third spherical mirror, wherein the projection shapes of incident-side mirror as well as aiming-side mirror are both rectangular, and wherein
light is suitable for being emergent from the point of emergence above the second spherical mirror and horizontally adjacent to the point of incidence.

15. The multi-pass cells according to claim 5, wherein the first circulation component as well as the second circulation component are respectively the PBWC component and BHWC component, wherein
the second spherical mirror is the rectangular concave spherical mirror with two upper and lower notches, wherein
first spherical mirror, third spherical mirror, fourth spherical mirror as well as fifth spherical mirror are all rectangular concave spherical mirrors, wherein projection shape of the aiming-side mirror is rectangular, wherein
light is suitable for being incident from point of incidence at notch above second spherical mirror and aiming at geometric center of fifth spherical mirror, and wherein light is also suitable for being emergent from point of emergence at notch below second spherical mirror.

16. The multi-pass cells according to claim 5, wherein the first circulation component as well as the second circulation component are respectively a BHWC component, wherein
first spherical mirror and second spherical mirror are respectively rectangular concave spherical mirrors with one notch on top and are symmetrical with respect to y-axis, wherein third spherical mirror is rectangular concave spherical mirror with two upper and lower notches, wherein fourth spherical mirror and fifth spherical mirror are both rectangular concave spherical mirrors, and fourth spherical mirror as well as fifth spherical mirror are arranged at the two notches of the third spherical mirror, wherein projection shape of aiming-side mirror is rectangular, wherein light is suitable for being incident from point of incidence at the notch of second spherical mirror and aiming at the geometric center of fifth spherical mirror, and wherein light is also suitable for being emergent from point of emergence at the notch of first spherical mirror.
